(19) United States
(12) Patent Application Publication
(10) Pub. No.: US 2005/0102149 A1
(43) Pub. Date: May 12, 2005

(54) System and method for providing assistance in speech recognition applications

(76) Inventor: Sherif Yacoub, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/706,408

(22) Filed: Nov. 12, 2003

(51) Int. Cl. G10L 11/00

(52) U.S. Cl. 704/277

(57) ABSTRACT

A system and method for finding a message within a speech recognition application. An assistance manager is activated for forming a selection path and finding a message associated with the selection path.

### BACKGROUND OF THE INVENTION

Speech dialog in voice recognition systems enables conversation to be conducted between a user and a speech recognition system. Speech dialog may be expressed in dialog mark-up languages, such as VoiceXML, and may employ “mixed initiative” which is a feature of speech dialog designs in interactive voice response (IVR) systems that allows, a user to speak freely to a speech recognition system.

In mixed initiative, the user is not tied to a particular directive grammar and hence, natural language sentences may be spoken. Representative dialog designs for mixed initiative include Nuance SayAnything software features (www.nuance.com) and Diane dialog machines. By way of example, a user may say: “I would like to fly from San Francisco Calif. to Orlando Fla. on Thursday November twenty ninth.” This free-style spoken sentence will then be parsed by the system using a natural language understanding component that will extract the departure city, arrival city, and travel date.

By further way of example, a speech dialog design for mixed initiative to provide assistance to a user, may be as follows:
System: “Please speak in your travel plan request.”
User: “I do not understand what you mean by travel plan request? Do you mean the departure time or arrival time or you want me to say both?”
System: “Please speak in the departure city, arrival city, and the preferred date and time for your trip.”

Limitations with speech dialog designs for mixed initiative include the requirement of natural language speech recognition, which has to support a very large vocabulary. Large vocabulary speech recognition is difficult and requires high processing resources. Such speech dialog systems for mixed initiative also require natural language processing (NLP) to parse the content of the recognized text and extract the required information. Therefore, mixed initiative is not an efficient solution to providing quick help information.

VoiceXML language for speech dialog design provides support for a help option which the user may call any time during a particular dialog. When the user says “help”, the user is taken to a global help dialog, which gives him general information about what the user is supposed to do. However, this solution provides no link between the help prompts and the grammars used in the dialog. Moreover, it is suited for general help and is not directed to quick help.

In a conventional state-based approach to determine a current status of the user, help is provided according to the user context information and status. Although the state-based approach improves help systems in interactive voice response applications, it does not address the “directed help” feature in which the user is only provided with the “help” capability that will take him/her, based on a current position in the dialog, to a predefined help menu, which usually speaks back to the user information about what the user may then do. As a result, the user will be provided with a long list of options depending on the context of a particular position in a conversation.

U.S. Pat. No. 6,298,324 to Zuberec et al describes a system and method to provide help information by listing all available options in response to a help command from a user. Any time the user does not know or has forgotten available options from which to select, he/she may speak a help command, such as: “What can I say?” Subsequently, all available options are repeated to the user, including those options that the user already knows. Thus, the help information system and method described in U.S. Pat. No. 6,298,324 to Zuberec et al produce slow processing, and the needs of the user are not optimized.

### SUMMARY OF EMBODIMENTS OF THE INVENTION

Embodiments of the present invention provide a method for finding a message within a speech recognition application comprising activating an assistance manager for forming a selection path, and finding a message associated with the selection path. A computer-readable medium is provided having instructions for performing the method for finding a message within a speech recognition application.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only and not by way of any limitation, wherein:

### BRIEF DESCRIPTION OF THE DRAWINGS

FIG. 1 is a functional block diagram of an embodiment of a speech recognition system.

FIG. 2 is a diagram of an exemplary computer assembly which may be employed to implement embodiments of the present invention.

FIG. 3 is a block flow diagram of an embodiment of the present invention.

FIG. 4 is a block flow diagram of an exemplary embodiment of the assistance manager for forming a selection path and producing a message corresponding to the selection path.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material which is subject to copyright protection. Computer program source code, object code, instructions, text or other functional information that is executable by a machine may be included in an appendix, tables, Figures or in other forms. The copyright owner has no objection to the facsimile reproduction of the specification as filed in the Patent and Trademark Office. Otherwise all copyright rights are reserved.

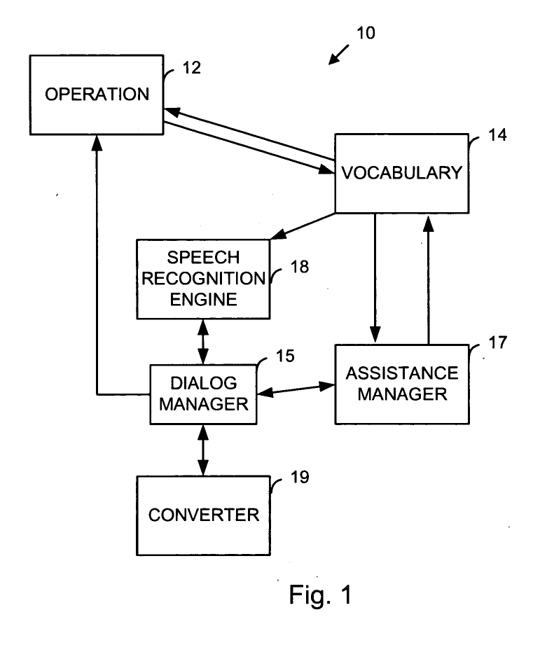

Referring now to FIG. 1 there is broadly exemplified a functional block diagram of an embodiment of a speech recognition system, generally illustrated as 10. The speech recognition system 10 may be an interactive voice recognition (IVR) system which recognizes utterances spoken by an individual. “Utterances” for various embodiments of the present invention means any word, phrase, number or other recognizable audio cue that is detectable as voice or audio input to the speech recognition system 10.

Embodiments of the speech recognition system 10 may be employed in any suitable setting, such as in a discrete setting (i.e., a setting designed to detect individual words and phrases that are interrupted by intentional pause, resulting in an absence of speech between the words and phrases), or in a continuous setting (i.e., a setting designed to detect and discern useful information from continuous speech patterns), all for assisting navigation by the user. As illustrated in FIG. 1, an embodiment of the speech recognition system 10 comprises an application 12, a vocabulary 14, an assistance manager 17, a speech recognition engine 18, a converter 19, and a dialog manager 15.

The application 12 may be any suitable type of audible-driven application br program for supporting audible-input commands. Audible-driven applications for supporting audible-input commands include, by way of example only, interactive voice response (IVR) applications using speech to communicate between a caller and a computer system. IVR applications include voice-driven browsing of airline information whereby the system provides flight information by simply asking the user to speak-in flight numbers or departure and arrival dates. Other IVR applications include voice-enabled banking, voice-driven mailboxes, and voice-activated dialing as offered by many cellular phone service providers. As indicated, application 12 may be a program for supporting audible-input commands, such as a program to send and receive e-mails on a computer, a program to open files on a computer, a program to operate an electronic device (e.g., a VCR, a radio, and so forth), a program to operate a device for communication (e.g., a telephone), or any other program to conduct or perform any suitable function.

The vocabulary 14 includes a complete list or set of available utterances that are capable of being identified and/or recognized by the speech recognition engine 18 when uttered or spoken by a user. The vocabulary 14 includes vocabulary which the speech recognition system 10 is attempting to implement at any particular time when receiving utterances from a user. The vocabulary 14 may be stored in any suitable storage device or memory of a computer, and is readily accessible by the application 12 and the assistance manager 17 when required. When a speech dialog is created, vocabulary 14 is employed.

The speech recognition engine 18 may be any suitable engine, module, or the like, that is capable of identifying and/or recognizing utterances from a user. More specifically, for various embodiments of the invention, the speech recognition engine 18 may be an automated speech recognition (ASR) engine. As illustrated in FIG. 1, after the speech recognition engine 18 identifies and/or recognizes an utterance from a user, the speech recognition engine 18 informs the application 12 of the identified and/or recognized utterance in order for the application 12 to subsequently execute any procedure associated with the utterance.

The assistance manager 17 may be any suitable engine, module, or the like, that is capable of providing assistance to the user in accordance with various embodiments of the present invention. During a dialog between a user and the voice recognition system 10, the user may at any time speak a certain word(s) to activate the assistance manager 17 to trigger an event (e.g., a help event) associated with the spoken certain word(s). These certain words may be termed “hot” key words which are part of the vocabulary 14 and may function as an interrupt event.

In an embodiment of the invention after an interrupt event has been implemented, such as by the uttering of a “hot” key word by the user, the user may then select a user-selective topic (e.g., “exhibit,” “contract,” “ID,” or “date”) to begin an active path and form a selection path. In an embodiment of the invention and as will be further explained hereafter, a formed selection path may be a previously created path stored in memory of a computer (identified below as “20”). A number of user-selective topics may be selected by the user and combined into the active path. Once all user-selective topics have been selected by the user, the combination of the selected user-selective topics produces or forms a selection path. Thus, by way of example only, if the user says “search” to commence searching, the active path is then “/search.” If the user subsequently says “exhibit,” to select search by exhibit, then the active path becomes “/search/exhibit.” Eventually the user will have enunciated all desired user-selective topics, the combination of which forms a selection path.

For various embodiments of the invention, activation of the assistance manager 17 causes the assistance manager 17 to form a selection path and find any message (e.g., a help message) associated with the selection path. More specifically and in an embodiment of the present invention, activation of the assistance manager 17 causes the assistance manager 17 to retrieve a path from a set of paths, preferably without describing or enumerating to the user all paths available within the set of paths. Activation of the assistance manager 17 may also cause the assistance manager 17 to retrieve an option from a set of options associated with the retrieved path. The assistance manager 17 then concatenates the retrieved path and retrieved option to form a selection path (i.e., sPath).

After the selection path is formed, the assistance manager 17 may then find or produce a message (e.g., a help message) associated with the selection path. Thus, and by way of example only, if the user says “what is exhibit,” the assistance manager 17 is activated as an event handling component for triggering a help event or help request. The word(s) “what is” may be the “hot” key words, causing the assistance manager 17 to trigger a help event or help request associated with “exhibit,” a user-selective topic, the first user-selective topic uttered by the user.

After a help event or help request associated with “exhibit” has been triggered, the user may subsequently obtain further assistance with any user-selective topic (e.g., a topic for an active path or an option associated with an active path). Once the user selects a user-selective topic, the selected topic becomes and/or commences an active path. Therefore, if the user says “what is exhibit,” “exhibit” is a user-selective topic which is part of an active path; and any topic(s) the user subsequently utters after “exhibit” becomes part of the active path associated with “exhibit.”

After a path or an active path associated with “exhibit” is identified, if the user says “what is ID,” the assistance manager 17 will identify the option “ID” from a set of options associated with the identified path or active path, then construct the help request by retrieving the identified path or active path (i.e., “exhibit”) and the identified option (i.e., “ID”) and subsequently concatenate them to form a selection path. The selection path is then looked up in a data base (e.g., a help table), and any message associated with the formed selection path is played or otherwise produced. The prompt is subsequently returned to the same position in the dialog between the user and the speech recognition system 10.

The converter 19 may be any suitable dialog interpreter employing prerecorded audio file(s) or any suitable text-to-speech engine that converts textual data to sound or audio data, which may be readily played by any suitable audio or sound output system to produce audio feedback to the user. In an embodiment of the invention illustrated in FIG. 1, the converter 19 may receive and/or take input from a user as speech signal(s) and use engine 18 (e.g., an automated speech recognition (ASR) engine) to extract the spoken text and pass it to the application 12 (e.g., a domain application) to be processed and/or to perform appropriate actions to serve the user. Thus for some embodiments of the invention, the converter 19, in combination with any suitable audio output system, converts textual data into audio data by verbally enunciating any recognizable speech, such as words, phrases, numbers, or the like.

The dialog manager 15 may be any suitable engine, module, or the like, that is capable of executing a conversation with a user of the speech recognition system 10. The dialog manager 15 cooperates with the assistance manager 17, the speech recognition engine 18, and the converter 19 for passing spoken text to the application 12 for performing any appropriate steps or actions to serve the user of the speech recognition system 10.

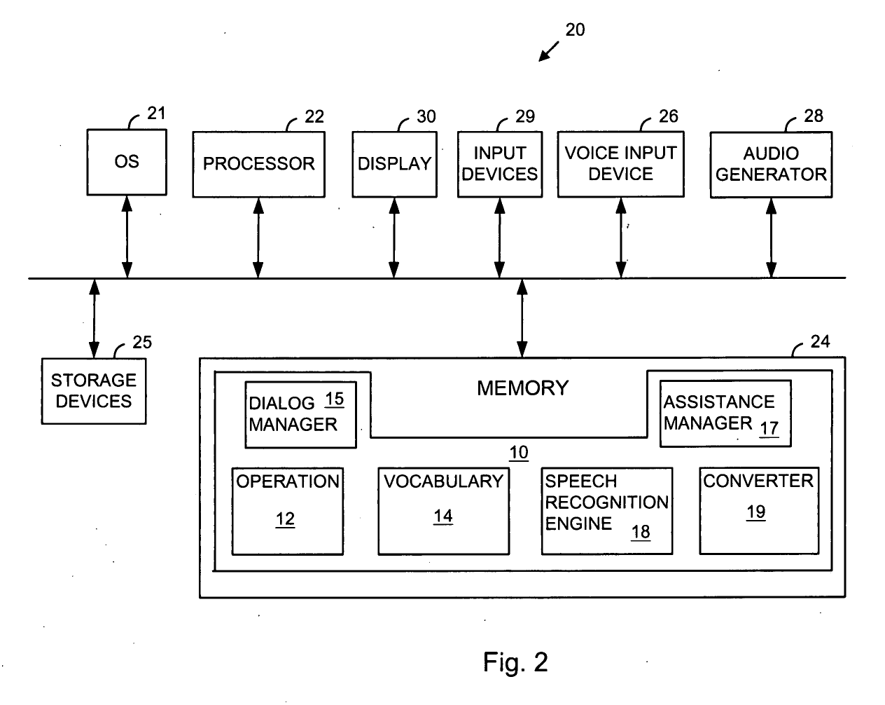

Embodiments of the speech recognition system 10 may be implemented in many different settings or contexts, such as, by way of example only, a computer, or computer assembly, generally illustrated as 20 in FIG. 2. The computer, or computer assembly, 20 exemplified in FIG. 2 may comprise electrically coupled hardware and software elements including an operating system 21, a processor 22, memory 24, storage devices 25, a voice input device 26 (e.g., microphone(s), telephone line(s) for IVR applications, etc.), and audio generator 28. The computer, or computer assembly, 20 may include a computer program and/or a computer-readable medium.

The operating system 21 may be a multi-task operating system 21 that is capable of supporting multiple applications. Thus, the operating system 21 may include various operating systems and/or data processing systems. By way of example only, the operating system 21 may be a Windows brand operating system sold by Microsoft Corporation, such as Windows 95, Windows CE, Windows NT, Windows Office XP, or any derivative version of the Windows family of operating systems. The computer, or computer assembly, 20 including its associated operating system 21 may be configured to support after-market peripherals including both hardware and software components. Voice commands would enter the computer, or computer assembly, 20 through a voice input port (not shown). The speech recognition system 10 receives the voice commands or utterances and executes procedures or functions based upon recognized commands. Feed-back in the form of verbal responses from the speech recognition system 10 may include audio output through an audio output port (not shown) with the assistance of the audio generator 28.

As illustrated in FIG. 2 and as previously indicated, the speech recognition system 10 includes an application 12, a vocabulary 14, an assistance manager 17, a speech recognition engine 18, a converter 19, and a dialog manger 15. The audio generator 28 in conjunction with the converter 19 forms a speech enunciator that is capable of saying verbally word(s), number(s), and phrase(s).

Memory 24 may be any suitable type of memory, including non-volatile memory and high-speed volatile memory. As illustrated in FIG. 2, the speech recognition system 10 may be embedded as software or firmware program stored in memory 24 and may execute on the processor 22. Optionally, the operating system 21 and any suitable computer program may be stored in memory 24 and may execute on the processor 22. Input devices 29 may comprise any number of devices and/or device types for inputting commands and/or data, including but not limited to a keyboard and a mouse.

A “computer” for purposes of embodiments of the present invention may be any device having a processor. By way of example only, a “computer” may be a mainframe computer, a personal computer, a laptop, a notebook, a microcomputer, a server, or any of the like. By further way of example only, a “computer” is merely representative of many diverse products, such as by way of example only: pagers, cellular phones, handheld personal information devices, stereos, VCRs, set-top boxes, calculators, appliances, dedicated machines (e.g., ATMs, kiosks, ticket booths, and vending machines, etc.), and any other type of computer-based product, and so forth. A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs.

A “processor” includes a system or mechanism that interprets and executes instructions (e.g., operating system code) and manages system resources. More particularly, a “processor” may accept a program as input, prepares it for execution, and executes the process so defined with data to produce results. A processor may include an interpreter, a compiler and run-time system, or other mechanism, together with an associated host computing machine and operating system, or other mechanism for achieving the same effect. A “processor” may also include a central processing unit (CPU) which is a unit of a computing system which fetches, decodes and executes programmed instruction and maintains the status of results as the program is executed. A CPU is the unit of a computing system that includes the circuits controlling the interpretation of instruction and their execution.

A “computer program” may be any suitable program or sequence of coded instructions which are to be inserted into a computer, well know to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport a program (e.g., a computer program) for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory.

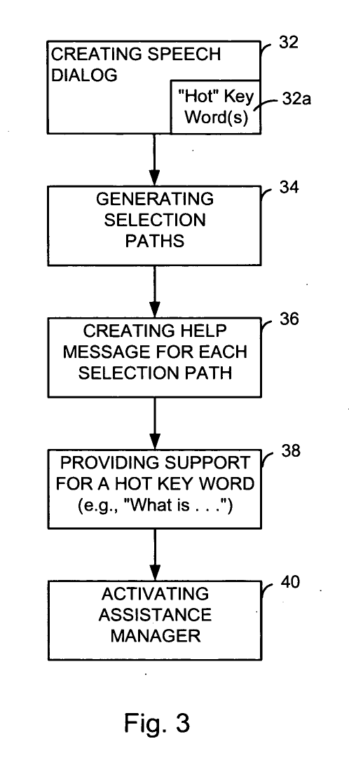

Referring now to FIG. 3 there is seen a block flow diagram of an embodiment of the present invention, including block 32 representing a speech dialog including block 32a for creating “hot” key word(s) (e.g., “what is . . . ”), block 34 representing generating selection paths, block 36 representing creating a help message for each selection path, block 38 representing providing support for “hot” key word(s), and block 40 representing activating assistance manager 17.

Creating a speech dialog in accordance with block 32 employs vocabulary 14, and may be with any suitable means and/or by any suitable method, such as providing mark up languages (e.g., VoiceXML) for expressing the speech dialog for driving the conversation between the user and the speech recognition system 10. “Hot” key words (e.g., “what is . . . ”) created in accordance with block 32a may be any suitable word or words for providing an interrupt event that activates the assistance manager 17 to trigger an event (e.g., a help event) associated with the “hot” key words. The created speech dialog includes vocabulary 14 which contains all the utterances, “hot” key words, sub dialogs and conversations that a user may implement or conduct to drive an application (i.e., application 12) in an IVR system, such as searching for a particular contract or flight information. An example of a speech dialog encoded in VoiceXML is as follows:

```
<!-- Ask the user how he would like to search -->
  <form id=“new_search”>
    <grammar type=“application/grammar+xml” src=“http://mill-pa-10:8080/examples/grammars/searchBy.grxml”/>
    <field name=“searchByWhat”>
    <grammar
                type=“application/grammar+xml”
                src=“http://mill-pa-10:8080/examples/grammars/searchBy.grxml#MainCriteria”/>
    <prompt>
      <audio> Hello, would you like to search by exhibit or contract?</audio>
    </prompt>
    <filled>
      <if cond=“‘exhibit’==searchByWhat”>
      <assign name=“searchCriteria” expr=“‘exhibit’”/>
      <goto next=“#exhibitForm”/>
      <elseif cond=“‘contract’==searchByWhat”/>
      <assign name=“searchCriteria” expr=“‘contract’”/>
      <goto next=“#contractForm”/>
      </if>
    </filled>
    <catch event=“noinput nomatch”>
      <audio> I am sorry. This is not a valid search criteria.</audio>
      <reprompt />
    </catch>
    </field>
  </form>
  <!-- ““ EXHIBIT ””
    The user selected the exhibit criterion
    Ask the user field he would like to search by
    -->
  <form id=“exhibitForm”>
    <grammar type=“application/grammar+xml” src=“http://mill-pa-10:8080/examples/grammars/searchBy.grxml”/>
    <field name=“exhibitField”>
    <grammar
                type=“application/grammar+xml”
                src=“http://mill-pa-10:8080/examples/grammars/searchBy.grxml#ExhibitCriteria”/>
    <prompt>
      <audio> You have selected the exhibit search criteria.
        You can search by: ID or Entity or Language or Business or Number or Description.
        Which one you would like to search by?
      </audio>
    </prompt>
    <filled>
      <assign name=“searchField” expr=“exhibitField”/>
      <goto next=“#fieldFillIn”/>
    </filled>
    <catch event=“noinput nomatch”>
      <audio> I am sorry. This is not a valid exhibit search criteria.</audio>
      <reprompt />
    </catch>
    </field>
  </form>
  <!-- ““ CONTRACT ””
    The user selected the contract criterion
    Ask the user field he would like to search by
    -->
  <form id=“contractForm”>
    <grammar type=“application/grammar+xml” src=“http://mill-pa-10:8080/examples/grammars/searchBy.grxml”/>
    <field name=“contractField”>
    <grammar
                type=“application/grammar+xml”
                src=“http://mill-pa-10:8080/examples/grammars/searchBy.grxml#ContractCriteria”/>
    <prompt>
      <audio> You have selected the contract search criteria.
        You can search by: ID or Amendment or Type or Business or date.
        Which one you would like to search by?
      </audio>
    </prompt>
    <filled>
      <assign name=“searchField” expr=“contractField”/>
      <goto next=“#fieldFillIn”/>
    </filled>
    <catch event=“noinput nomatch”>
      <audio> I am sorry. This is not a valid contract search criteria.</audio>
      <reprompt />
    </catch>
    </field>
  </form>
```

Generating selection paths in accordance with block 34 may be with any suitable means and/or by any suitable method, such as by analyzing the speech dialog that was created from a dialog description (e.g., VoiceXML), and generating what may be termed as “selection paths,” or “sPaths” for brevity purpose. A sPath holds information about how the user reaches a specific selection option (e.g., a specific point in a conversation) starting from a dialog root node. For each possible selection path (e.g., a decision option) that the user can make at any time in the conversation, a sPath will be created. By way of example only, the following are representative of some sPaths generated for the Voice XML speech dialog design immediately set forth above as an example for creating a speech dialog design for contract searches:
/contract
/exhibit
/contract/ID
/contract/Amendment
/contract/Type
/contract/Business
/contract/date.
/exhibit/ID
/exhibit/Entity
/exhibit/Language
/exhibit/Business
/exhibit/Number
/exhibit/Description

Thus, by way of example only, the commencement of a sPath may be “contract” or “exhibit”, both which may be designated as “an active path.” Any active path may be the beginning of a sPath. If “contract” has been identified as an active path, possible options for completing a sPath from “contract” include: ID, Amendment, Type, Business or date. Similarly, if “exhibit” has been identified as an active path, possible options for completing a sPath from “exhibit” include: ID, Entity, Language, Business, Number, or Description. Thus, a suitable dialog analysis method takes into consideration all user selection possibilities, and resolves loops as a result of “go to” statements construct.

Creating a help message for each sPath in accordance with block 36 may be with any suitable means and/or by any suitable method, such as by creating a help table which may be stored in any suitable location (e.g., storage devices 25, memory 24, etc). Help messages may be played back to the user if the user asks for help on a particular selection option which is mapped to a sPath. By way of example only, the following Table I illustrates a table showing help messages for the Voice XML speech dialog design immediately set forth above as an example:

TABLE I

| sPath | Quick Help Message |
|---|---|
| /contract | You can search the legal documents by |
| | using information that you know about |
| | an existing contract; like ID, |
| | amendment, type, etc. |
| /exhibit | You can search the legal documents by |
| | using information that you know about |
| | an existing exhibit; like language, |
| | number, date, etc. |
| /contract/ID | You can search the contracts database |
| | by saying the contract system |
| | identification number. This should be |
| | a seven digits number on top of the |
| | contract file. |
| /contract/Type | Each contract has a type such as |
| | contractual, permanent, etc. You can |
| | speak in the type of the contract you |
| | are looking for. |
| /contract/Business | What type of business are you looking |
| | for? For instance, micro-processors, |
| | telecommunications, etc. |
| /contract/Date | Please speak in the date of the |
| | contract you are looking for. Please |
| | say the month and then the year. You |
| | do not need to include the day. |
| /exhibit/ID | You can search the exhibit databases |
| | by saying the system identification |
| | number. This is a three digits number |
| | at the bottom of the exhibit file. |

Providing support for a “hot” key word or phrase in accordance with block 38 may be with any suitable means and/or by any suitable method, such as providing support for “what is . . . ” by creating and employing a user defined “hot” key word or phrase. As indicated previously, creating user defined “hot” key word or phrase may be in accordance with block 32a where the “hot” key word(s) or phrase is/are created. “Hot” key word or words may be part of any dialog design language including vocabulary 14 and are often supported as an interrupt event that is handled by a dialog interpreter, such as converter 19. By way of example only, the word or words “what is . . . ” may be designated or defined as “hot” key word(s). When a user says “what is exhibit,” an interrupt event associated with these words is triggered. In an embodiment of the invention, this interrupt event step is handled by a suitable help manager, such as the assistance manager 40.

Activating the assistance manager 40 for quick assistance or help in accordance with block 47 may be with any suitable means and/or by any suitable method, such as by the user saying or uttering a “hot” key word or phrase (e.g., “what is . . . ”). After a “hot” key word or phrase has been mentioned or stated by the user, the assistance manager 17 is activated to form a selection path and find any message (e.g., a help message) associated with the selection path. More specifically and for various embodiments of the present invention, activation of the assistance manager 17 causes the assistance manager 17 to identify and to retrieve a path from a set of paths, preferably without describing or enumerating to the user all paths available within the set of paths, and to subsequently retrieve an option from a set of options associated with the retrieved path. The assistance manager 17 then concatenates the retrieved path and retrieved option to form a selection path (i.e., sPath).

Thus, the assistance manager 17 is activated in accordance with block 40 when the user states a “hot” key word(s) or phrase. The speech recognition system 10 employs automated speech recognition (e.g., the speech recognition engine 18) to identify a word or words representing a user-selective topic. A user-selective topic may be any suitable topic, such as by way of example only, an active path or option for which the user is inquiring. By way of example only, for the “hot” key words “what is exhibit”, the active path that the user is asking about is “exhibit.”

The help or assistance provided by an activated assistance manager 17 is context sensitive. By way of example only, and as illustrated in Table I, a help message for /contract/ID is different from a help message for /exhibit/ID although both are asking about an ID. Hence, the speech recognition system 10 including any associated computer (e.g., computer 20) preferably continually monitors and updates a selected active path variable in order to keep track of active path selections made by the user and are at issue in any speech dialogue conversation. To do this, an active path variable (e.g., “contract” or “exhibit”) is updated to reflect what part of the conversation the user is in at any point in time. As the user uses the speech recognition system 10, the user speaks utterances that may be employed to construct an active path. For example and as indicated, if the user says “search,” to start searching, the active path is now “/search.” The speech recognition system 10 including any associated computer (e.g., computer 20) continually monitors the active path or “/search” such that if the user subsequently utters a user-selective topic such as “exhibit” to select the search by exhibit, then “exhibit” is concatenated with “/search” (and not any other topic) and the active path subsequently becomes “/search/exhibit.” Therefore, after a user states the “hot” key words “what is exhibit” in order to indicate that the active path that the user is asking about is “exhibit”, the speech recognition system 10 remembers and keeps track of the fact that the active path pertains to “exhibit.” Thus, when the user subsequently states an option (e.g., “ID”) to produce a user-stated option, the speech recognition system 10 knows that the user-stated option (e.g., “ID”) is to be associated with “exhibit” and not with some other active path, such as “contract,” and will subsequently produce a help message associated with exhibit/user-stated option (e.g., exhibit/ID) and not a help messaged associated with contract/user-stated option (e.g., contract/ID).

After the assistance manager 17 forms a selection path, the selection path is subsequently looked up in a data base (e.g., a help table), and any message (e.g., a help message) associated with the formed selection path is played or otherwise produced. The prompt is subsequently returned to the same position in the speech dialog between the user and the speech recognition system 10. The flow of the speech dialog between a user and the speech recognition system 10 is not changed or affected. After a quick help message associated with a sPath is played, the user is returned to the exact same part of the speech dialog from which the user departed. A conversation between the user and the speech recognition system 10 may then continue from the part of the speech dialog from which the user departed.

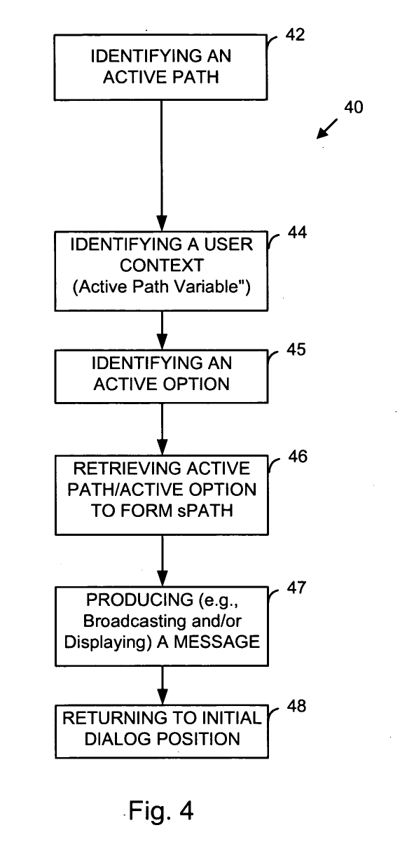

Referring now to FIG. 4 there is seen a block flow diagram of an exemplary embodiment of the assistance manager 17 for forming a selection path and producing a message corresponding to the selection path. The block flow diagram includes block 42, block 44, block 45, block 46, block 47, and block 48. Block 42 represents identifying an active path. Block 44 represents identifying a user context (e.g., an active path, such as “contract” or “exhibit”). Block 45 represents identifying an active option. Block 46 represents retrieving an active path/active option to form a selection path. Block 47 represents producing a message, and block 48 represents returning to initial dialog position after the message has been produced.

Activation of the assistance manager 17 causes the assistance manager 17 to identify in accordance with block 42 an active path (e.g., “exhibit”) from a set of paths (e.g., a set comprising “exhibit” and “contract”), preferably without describing or enumerating to the user all paths available within the set of paths. As indicated, after the active path has been identified by the activation manager 17, the activation manager 17 identifies a user context in accordance with block 44. Because the assistance provided by the assistance manager 17 is context sensitive, the assistance manager 17 preferably continually monitors and/or updates a selected active path (e.g., “exhibit”) variable in order to keep track of the active path selection made by the user and to reflect what part of the conversation the user is in at any point in time. Activation of the assistance manager 17 further causes the assistance manager 17 to identify in accordance with block 45 an active option (e.g., “ID”) from a set of options (e.g., a set of options comprising ID, Entity, Language, Business, Number, or Description). After the assistance manager 17 has identified an active path and an active option, the assistance manager 17 retrieves in accordance with block 46 the identified active path and identified active option. As previously mentioned, the assistance manager 17 may then concatenate the retrieved path and retrieved option to form a selection path (i.e., sPath) from which a message (e.g., a help message) associated with the selection path may be subsequently found and produced (e.g., displayed or broadcasted) in accordance with block 47. After the message has been produced, the user is returned per block 48 to the exact same part of the speech dialog from which the user departed.

Embodiments of the present invention will be illustrated by the following Example by way of illustration only and not by way of any limitation. The following Example is not to be construed to unduly limit the scope of the invention.

### EXAMPLE

Voice Extensible Markup Language, VoiceXML (http://www.w3.org/TR/voicexml/), is becoming a standard for creating audio dialogs that feature synthesized speech, recognition of spoken and DTMF key input, telephony, and mixed-initiative conversations. Currently, VoiceXML is a well mature technology that could be used to implement dialogs for IVR systems. VoiceXML uses XML as the encoding language for dialogs between humans and systems. While embodiments of the present invention are not to be tied to any particular encoding mechanism, such as XML for VoiceXML, VoiceXML will be used to illustrate embodiments of the present invention. It is to be understood that the spirit and scope of embodiments of the present invention include any suitable mark-up language, source code, or syntax.

The following is a sample VoiceXML design for an interactive voice response system for a legal document search application. The following VoiceXML design employs embodiments of the present invention, and was tested using Nuance Voice Web Server (VWS), Nuance Automated Speech Recognizer (ASR), and Nuance Text-To-Speech (TTS) on a distributed workstation environment.

```
<?xml version=“1.0”?>
<!DOCTYPE vxml PUBLIC “-//Nuance/DTD VoiceXML 2.0//EN”
“http://voicexml.nuance.com/dtd/nuancevoicexml-2-0.dtd”>
<vxml xmlns=“http://www.w3.org/2001/vxml” xmlns:nuance=“http://voicexml.nuance.com/dialog”
version=“2.0”>
    <meta name=“Generator” content=“V-Builder 2.0.0”/>
    <var name=“sPath” expr=“‘’”/>
    <var name=“currentDialog” expr=“‘new_search’”/>
    <var name=“searchCriteria” expr=“‘searchCriteria’”/>
    <var name=“searchField” expr=“‘someField’”/>
    <var name=“searchFieldValue” expr=“‘someFieldValue’”/>
    <!-- when the user requests a search go back to the main dialog -->
    <link event=“hp.legel.search”>
    <grammar>
        [search]
    </grammar>
    </link>
    <catch event=“hp.legel.search”>
        <audio> You have requested a new search.</audio>audio>
        <!-- clearing all the variables to be ready for a new search-->
        <assign name=“searchCriteria” expr=“‘someCriteria’”/>
        <assign name=“searchField” expr=“‘someField’”/>
        <assign name=“searchFieldValue” expr=“‘someFieldValue’”/>
        <goto next=“#new_search“/>
    </catch>
    <link event=“hp.legel.whatiscontract”>
    <grammar mode=“voice” type=“application/x-nuance-gsl”>
        ( what is contract )
    </grammar>
    </link>
    <catch event=“hp.legel.whatiscontract”>
        <assign name=“sPath” expr=“sPath + ‘/contract’”/>
        <goto next=“#helpManager”/>
    </catch>
    <link event=“hp.legel.whatisexhibit”>
    <grammar mode=“voice” type=“application/x-nuance-gsl”>
        ( what is exhibit )
    </grammar>
    </link>
    <catch event=“hp.legel.whatisexhibit”>
        <assign name=“sPath” expr=“sPath + ‘/exhibit’”/>
        <goto next=“#helpManager”/>
    </catch>
    <link event=“hp.legel.whatisID”>
    <grammar mode=“voice” type=“application/x-nuance-gsl”>
        ( what is id )
    </grammar>
    </link>
    <catch event=“hp.legel.whatisID”>
        <assign name=“sPath” expr=“sPath + ‘/ID’”/>
        <goto next=“#helpManager”/>
    </catch>
    <link event=“hp.legel.whatisType”>
    <grammar mode=“voice” type=“application/x-nuance-gsl”>
        ( what is type )
    </grammar>
    </link>
    <catch event=“hp.legel.whatisType”>
        <assign name=“sPath” expr=“sPath + ‘/Type’”/>
        <goto next=“#helpManager”/>
    </catch>
    <link event=“hp.legel.whatisBusiness”>
    <grammar mode=“voice” type=“application/x-nuance-gsl”>
        ( what is business )
    </grammar>
    </link>
    <catch event=“hp.legel.whatisBusiness”>
        <assign name=“sPath” expr=“sPath + ‘/Business’”/>
        <goto next=“#helpManager”/>
    </catch>
    <link event=“hp.legel.whatisDate”>
    <grammar mode=“voice” type=“application/x-nuance-gsl”>
        ( what is date )
    </grammar>
    </link>
    <catch event=“hp.legel.whatisDate”>
        <assign name=“sPath” expr=“sPath + ‘/Date’”/>
        <goto next=“#helpManager”/>
    </catch>
    <!-- Ask the user how he would like to search -->
      <form id=“new_search”>
        <block>
            <assign name=“currentDialog” expr=“‘new_search’”/>
            <assign name=“sPath” expr=“‘’”/>
        </block>
      <grammar type=“application/grammar+xml” src=“http://mill-pa-
10:8080/examples/grammars/searchBy.grxml”/>
      <field name=“searchByWhat”>
            <grammar
      type=“application/grammar+xml”
      src=“http://mill-pa-10:8080/examples/grammars/searchBy.grxml#MainCriteria”/>
            <prompt>
                <audio> Hello, would you like to search by exhibit or contract?</audio>
            </prompt>
            <filled>
                <if cond=“‘exhibit’==searchByWhat”>
                    <assign name=“searchCriteria” expr=“‘exhibit’”/>
                    <goto next=“#exhibitForm”/>
                <elseif cond=“‘contract’==searchByWhat”/>
                    <assign name=“searchCriteria” expr=“‘contract’”/>
                    <goto next=“#contractForm”/>
                </if>
            </filled>
            <catch event=“noinput nomatch”>
                <audio> I am sorry. This is not a valid search criteria.</audio>
                <reprompt />
            </catch>
        </field>
      </form>
      <!-- ““ EXHIBIT ””
            The user selected the exhibit criterion
            Ask the user for the field he would like to search by
            -->
      <form id=“exhibitForm”>
        <block>
            <assign name=“currentDialog” expr=“‘exhibitForm’”/>
            <assign name=“sPath” expr=“‘/exhibit’”/>
        </block>
      <grammar type=“application/grammar+xml” src=“http://mill-pa-
10:8080/examples/grammars/searchBy.grxml”/>
      <field name=“exhibitField”>
            <grammar
      type=“application/grammar+xml”
      src=“http://mill-pa-10:8080/examples/grammars/searchBy.grxml#ExhibitCriteria”/>
            <prompt>
```

| <audio> | You have selected the exhibit search criteria. |
|---|---|
| | You can search by. |
| | ID or |
| | Name or |
| | Entity or |
| | Language or |
| | Business or |
| | Number or |
| | Description. |
| | Which one you would like to search by? |

```
                </audio>
            </prompt>
            <filled>
                <assign name=“searchField” expr=“exhibitField”/>
                <goto next=“#fieldFillIn”/>
            </filled>
            <catch event=“noinput nomatch”>
                <audio> I am sorry. This is not a valid exhibit search criteria.</audio>
                <reprompt />
            </catch>
      </field>
      </form>
      <!-- ““ CONTRACT ””
            The user selected the contract criterion
            Ask the user field he would like to search by
            -->
        <form id=“contractForm”>
        <block>
            <assign name=“currentDialog” expr=“‘contractForm’”/>
            <assign name=“sPath” expr=“‘/contract’”/>
        </block>
        <grammar type=“application/grammar+xml” src=“http://mill-pa-
10:8080/examples/grammars/searchBy.grxml”/>
        <field name=“contractField”>
            <grammar
                type=“application/grammar+xml”
                src=“http://mill-pa-
        10:8080/examples/grammars/searchBy.grxml#ContractCriteria”/>
            <prompt>
```

| <audio> | You have selected the contract search criteria. |
|---|---|
| | You can search by |
| | ID or |
| | Entity or |
| | Ammendement or |
| | Type or |
| | Business or |
| | date. |
| | Which one you would like to search by? |

```
                </audio>
            </prompt>
            <filled>
                <assign name=“searchField” expr=“contractField”/>
                <goto next=“#fieldFillIn”/>
            </filled>
            <catch event=“noinput nomatch”>
                <audio> I am sorry. This is not a valid contract search criteria.</audio>
                <reprompt />
            </catch>
        </field>
      </form>
<!-- ““ fieldFillIn ””
            Ask the user to speack in the value of the fild to be used in the search.
            -->
    <form id=“fieldFillIn”>
      <block>
        <assign name=“currentDialog” expr=“‘fieldFillIn’”/>
      </block>
      <grammar type=“application/grammar+xml” src=“http://mill-pa-
10:8080/examples/grammars/searchBy.grxml”/>
      <field name=“fieldValue”>
            <grammar
                type=“application/grammar+xml”
                src=“http://mill-pa-10:8080/examples/grammars/searchBy.grxml#fieldValues”/>
            <prompt>
                <audio> Please speak the value of the field. </audio>
            </prompt>
            <filled>
                <assign name=“searchFieldValue” expr=“fieldValue”/>
                <!-- <goto next=“#getResults”/>-->
            </filled>
            <catch event=“noinput nomatch”>
                <audio> I am sorry. I did not hear that.</audio>
                <reprompt />
            </catch>
        </field>
        <subdialog name=“finishUp” src=“#getResults2”>
            <param name=“searchCriteria” expr=“searchCriteria”/>
            <param name=“searchField” expr=“searchField”/>
            <param name=“searchFieldValue” expr=“searchFieldValue”/>
            <filled>
                <audio> finished up </audio>
                <goto next=“#new_search”/>
            </filled>
        </subdialog>
        <block>
                <audio> restart </audio>
                <goto next=“#new_search”/>
        </block>
      </form>
        <!-- ““ getResults2 ””
            Contact the server and get the data
            -->
        <form id=“getResults2”>
        <var name=“searchCriteria”/>
        <var name=“searchField”/>
        <var name=“searchFieldValue”/>
            <block>
                <submit
                    next=“http://hplsyomni:8080/examples/servlet/legelDocsServlet”
                    method=“get”
                    namelist=“searchCriteria searchField searchFieldValue” />
                <return/>
            </block>
            <catch event=“noinput nomatch”>
                <return/>
            </catch>
        </form>
      <form id=“helpManager”>
        <block>
                <if cond=“‘/contract’==sPath”>
                    <prompt>
                        You can search the legal documents by using information you know about
an existing contract.
                        For example ID, amendment, type.
                    </prompt>
                <elseif cond=“‘/exhibit’==sPath” />
                    <prompt>
                            You can search the legal documents by using information you
know about an existing exhibit;
              like language, number, date, etc.
                    </prompt>
                <elseif cond=“‘/contract/ID’==sPath” />
                    <prompt>
                            You can search the contracts database by say the contract
system identification number.
              This should be a seven digits number on top of the contract file.
                    </prompt>
                <elseif cond=“‘/exhibit/ID’==sPath” />
                    <prompt>
                        You can search the exhibit databases by saying the system
identification number.
              This is a three digits number at the bottom of the exhibit file.
                    </prompt>
                <elseif cond=“‘/contract/Type’==sPath” />
                    <prompt>
                        Each contract has a type such as contractual, permanent, etc. What is
the type of the contract?
                    </prompt>
                <elseif cond=“‘/contract/Business’==sPath” />
                    <prompt>
                        What type of business are you looking for? For instance,
microporcessors, telecommunications, etc.
                    </prompt>
                <elseif cond=“‘/contract/Date’==sPath” />
                    <prompt>
                        Please speak in the date of the contract you are looking for. Please
say the month and then the year.
              You do not need to include the day.
                    </prompt>
                <else/>
                    <prompt>
              No help is defined for your selection.
                    </prompt>
                </if>
                <goto expr=“‘#’ + currentDialog”/>
            </block>
    </form>
</vxml>
```

### CONCLUSION

Embodiments of the speech recognition system 10 of the present invention include a help function which interfaces with a user to offer expeditious assistance to the user by bypassing the enunciation of all available options available to the user, including those options which the user already knows. The user is allowed to ask about a particular option; hence, help on all of the available options of a particular conversation position does not have to be listed or enunciated. Thus, if a user says “Help” or “What can I say?” or any other “hot” key words which invokes a help or assistance function, embodiments of the present invention detects the spoken utterance or “hot” key word, obtains a list of certain utterances from the vocabulary 14, and with the assistance of the converter 19, instead of verbally enunciating all of the obtained utterances for the user to hear, bypasses the enunciation and goes directly to the particular option or selection that the user does not understand, and provides help messages accordingly. Thus, the user's interface provides help messages that are directed to the particular option or selection that user does not understand without the user having to hear and waste time laboriously listening to an entire option lists.

Therefore, embodiments of the present invention provides help information to improve usability in speech recognition applications including interactive voice response systems. The provision of help information is expedited to the application user by providing help messages that are directed to a particular option or selection that a user does not understand; hence, saving the users time, shortening call time in telephony applications, and improving dialog (human/machine interaction) quality.

Embodiments of the present invention also provide a user driven or directed help feature employing techniques such as “What is ‘abc’?”, and its variants to provide help information on the particular option/selection “abc” in speech-enabled applications. Using the “what is . . . ” feature, the user does not have to hear the contents of all help messages, does not have to parse a general help menu, and is directly connected to the help messages related to his or her needs.

Reference throughout the specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A processor-based method for producing a message during a speech recognition application comprising:
retrieving an identified path from a set of paths;
retrieving an identified option from a set of options associated with the identified path;
concatenating the identified path and the identified option to form a selection path; and
producing a message associated with the selection path.

2. The processor-based method of claim 1 wherein said identified path is retrieved without executing a general assistance command for describing to a user all available paths.

3. The processor-based method of claim 1 wherein said identified path is retrieved without having described to a user any paths from the set of paths other than the identified path.

4. The processor-based method of claim 1 additionally comprising continually monitoring the identified path to insure that the identified option is associated with the identified path.

5. A message produced in accordance with the method of claim 1.

6. A computer-readable medium comprising instructions for:
retrieving an identified path from a set of paths;
retrieving an identified option from a set of options associated with the identified path;
concatenating the identified path and the identified option to form a selection path; and
producing a message associated with the selection path.

7. A speech recognition system comprising:
an application;
an assistance manager for forming a selection path;
a vocabulary accessible by the application and the assistance manager and including a set of utterances applicable to the application; and
a speech recognition engine to recognize the utterances.

8. The speech recognition system of claim 7 additionally comprising a converter.

9. The speech recognition system of claim 7 wherein said vocabulary additionally includes at least one hot key word.

10. The speech recognition system of claim 7 additionally comprising a dialog manager.

11. The speech recognition system of claim 8 additionally comprising a dialog manager.

12. An operating system incorporating the speech recognition system of claim 7.

13. A computing device incorporating the speech recognition system of claim 7.

14. A system for finding a message during a speech recognition application comprising:
an application;
a vocabulary accessible by the application and including a set of utterances applicable to the application;
a speech recognition engine to recognize the utterances; and
means for forming a selection path and for finding a message associated with the selection path during a speech recognition application.

15. The system of claim 14 additionally comprising a converter.

16. The system of claim 14 additionally comprising a dialog manager.

17. The system of claim 15 additionally comprising a dialog manager.

18. A processor-based method for providing assistance in a speech recognition application, comprising:
creating a speech dialog for enabling a conversation to be conducted in a speech recognition application between a user and a speech recognition system;
providing support for an interrupt event during a conversation between a user and a speech recognition system;
creating a selection path;
creating a message for the selection path; and
interrupting a conversation between a user and a speech recognition system for providing assistance to the user.

19. The processor-based method of claim 18 wherein said interrupt event comprises a hot key word.

20. The processor-based method of claim 18 wherein said interrupting the conversation comprises interrupting the conversation with the interrupt event.

21. The processor-based method of claim 19 wherein said interrupting the conversation comprises uttering the hot key word by the user.

22. The processor-based method of claim 18 wherein said interrupting a conversation comprises activating an assistance manager.

23. The processor-based method of claim 18 additionally comprising:
retrieving an identified path from a set of paths;
retrieving an identified option from a set of options associated with the identified path;
concatenating the identified path and the identified option to form the selection path; and
producing the message associated with the selection path for providing assistance to the user.

24. The processor-based method of claim 23 wherein said identified path is retrieved without executing a general assistance command for describing to the user all available paths.

25. The processor-based method of claim 23 wherein said identified path is retrieved without having described to the user any paths from the set of paths, other than the identified path.

26. The processor-based method of claim 18 wherein said interrupting a conversation comprises activating an assistance manager for finding the selection path and for producing the message for the selection path.

27. The processor-based method of claim 19 wherein said interrupting the conversation comprises uttering by the user the hot key word along with a user-selective topic.

28. The processor-based method of claim 27 wherein said user-selective topic is selected from a group of topics consisting of an active path and an option.

29. The processor-based method of claim 28 wherein said selection path comprises said user-selective topic.

30. The processor-based method of claim 28 wherein said selection path comprises said active path.
